(19) United States
(12) Patent Application Publication
(10) Pub. No.: US 2015/0066721 A1
(43) Pub. Date: Mar. 5, 2015

(54) DEVICE AND METHOD FOR PROCESSING DATA REPRESENTATIVE OF FINANCIAL TRANSACTIONS

(71) Applicant: BORSA ITALIANA S.P.A., MILANO (IT)

(72) Inventors: Enrico MANDELLI, CATTOLICA (RIMINI) (IT); Astridel RADULESCU, MILANO (IT)

(21) Appl. No.: 14/476,686

(22) Filed: Sep. 3, 2014

(30) Foreign Application Priority Data
Sep. 5, 2013 (IT) MI2013A001456

(51) Int. Cl. G06Q 40/00

(52) U.S. Cl. CPC G06Q 40/00
USPC 705/35

(57) ABSTRACT

The invention relates to a device (1) for processing data representative of financial transactions (D1) implemented by operators (j), comprising a processing unit (10) configured to process the data (D1), and comprising an acquisition module (101) for acquiring the data representative of financial transactions (D1), a first calculation module (102) configured to calculate a first vector ( w̅) of summary indicators (Wij(t)), a first analysis indicator (IRj) and a second analysis indicator (Fj), as a function of the data representative of financial transactions (D1), the processing unit (10) further comprising a comparison module (103) configured to compare the first analysis indicator (IRj) and the second analysis indicator (Fj) with respective predefined values (P1, P2) of relevance, and to determine, as a function of the comparisons, whether the operator (j) is relevant (j*) for an assessment of the presence of momentum ignition (MI) and whether the first analysis indicator (IRj) and second analysis indicator (Fj) are representative of a possible behaviour of momentum ignition (MI).

The invention further relates to a method for processing data representative of financial transactions (D1); in a preferred embodiment, the method is implemented by means of a computer.

### CROSS REFERENCE TO RELATED APPLICATIONS

The present application claims priority to Italian Patent Application No. MI2013A001456 filed on Sep. 5, 2013, which is incorporated herein by reference in its entirety.

### BACKGROUND OF THE INVENTION

The present invention relates to a device for processing data representative of financial transactions.

In particular, the present invention relates to a device for processing data representative of financial transactions in order to identify given types of so-called “market abuse”, in particular the specific case of market abuse known as momentum ignition.

Even more particularly, the present invention relates to a method for processing data representative of financial transactions in order to identify the specific case of market abuse known as momentum ignition.

### PRIOR ART

It is known that in financial markets, particularly in dealings over online trading platforms, the daily, intraday and high-frequency transactions, mainly undertaken by operators authorized to trade on stock and derivatives markets, are under constant monitoring in order to identify, among other things, the transactions deemed suspect within the scope of market abuse regulations.

In general, a situation of market abuse can occur when investors, among other things, directly or indirectly suffer unfavorable consequences due to the behaviour of other individuals or entities, including that of taking advantage of confidential information, distorting the mechanism for determining the prices of financial instruments or disclosing false or misleading information.

There is a great need in the financial industry to identify, with a reasonable degree of approximation, transactions attributable to so-called momentum ignition strategies, that is, strategies consisting in the entry of a series of orders and the conclusion of contracts with the objective of creating a rapid increase or decrease in the prices of the orders entered by other market participants.

Such strategies can in fact provide a signal to the market which determines the activation of other orders—also automatic ones—originated, by way of example, by trading or stop order/stop loss algorithms, which amplify the aforesaid increases/decreases in such a way that the operator who has activated the strategy succeeds in unwinding a previously created position at favorable prices.

Although everyone agrees in the defining such strategies as manipulative, the guidelines available to the industry normally address the problem from a theoretical standpoint, without useful applicative indications for identifying the suspect cases in a sufficiently precise manner.

Automatically recognizing and identifying the dynamics of momentum ignition—also those taking place over different trading platforms and through the combined use of stocks and derivative instruments—is essential for the authorities, stock exchanges and financial intermediaries not only in Italy, but also in all countries where developed financial markets are present. This need is based on the obligations under applicable laws and the objective of maintaining a high standard of quality of the financial market, protecting investors and ensuring that trading is carried out normally.

There are known approaches for identifying cases of momentum ignition which are based on analyzing peak volumes and large price movements in relation to market volatility and estimating potential profit and loss (P&L).

However, these approaches have the following drawbacks:
they are not based on the activity of each individual participant, but rather give rise only to assessments of a general character, which are difficult to use at an operational level;
they require a further effort of subjective interpretation in order to be able to arrive at a conclusion.
they do not provide a summary indicator based on the exact moment at which each trading decision is made;

The object of the present invention is to produce a device for processing data representative of financial transactions which solves the aforesaid problems by overcoming the drawbacks of the prior art.

A specific object of the present invention is to produce a device for processing data representative of financial transactions which enables a rapid and reliable identification of the presence of momentum ignition.

Another object of the present invention is to provide a computer-implemented method for processing data representative of financial transactions which solves the aforesaid problems by overcoming the drawbacks of the prior art.

A further object of the present invention is to provide a computer-implemented method for processing data representative of financial transactions which enables a rapid and reliable identification of the presence of momentum ignition.

### SUMMARY OF THE INVENTION

These and other objects are achieved by a device for processing data representative of financial transactions according to what is described in the accompanying claims 1 to 16.

The invention, as described, achieves the following technical effects:
precise temporal analysis of the activation of a momentum ignition strategy;
objective recognition of a situation of momentum ignition;
reduction in the time needed to analyze a probable situation of momentum ignition;
real-time analysis of momentum ignition;
rapid, simple analysis of historical data related to momentum ignition.

In other words, the invention makes it possible to:
identify momentum ignition strategies implemented through several markets, also by combining products of different nature (such as, for example, stocks and index-based derivatives);
compare data among the various market players and analyzing data also originating from different markets; that is, the invention also enables specific cases of momentum ignition implemented through the use of financial instruments traded on several trading venues, i.e. markets where trading takes place, for example stock and derivatives markets, to be identified;
standardize the input information (also originating from platforms with heterogeneous protocols) and interpret the data in order to recognize the specific case being looked for;
save on the hours of work formerly necessary for subjectively interpreting data;
analyze historical data (back-testing) automatically and in a short time.

In particular, the invention describes a method for processing data representative of financial transactions, in particular implemented by means of a computer, wherein the method achieves the preset objects according to what is described in the accompanying claims 17 to 20.

In particular, the technical effects achieved are to be considered “further technical effects” in consideration of the fact that the method described represents a sequence of steps actually performed which achieve a plurality of effects.

Moreover, the invention was subjected to experimentation on historical data (approximately a year and a half of data with several tens of millions of high-frequency transactions carried out on two platforms with different protocols) and it provided coherent and consistent results.

The invention proved to be effective and efficient both over a daily and intraday time horizon.

The invention can be easily adapted to provide results also in real time, that is, while the trading itself is taking place.

The experimentation, still ongoing, to adapt the device to other specific cases of market abuse (such as so-called spoofing or layering) is promising.

The invention can be conveniently exploited by:
Stock exchanges and authorities, which can use the device/method of the invention based on the identity of the final counterparties and further detail the results up to the maximum level of granularity available (account, sub-account, client);
intermediaries and investment banks, which can use the device/method of the invention to compare the behaviour of traders, trader desks, clients and automatic trading systems connected to the same bank or company.

The results can moreover be interpreted on an ordinal scale and become in turn inputs for further analyses conducted with nonparametric statistical techniques.

The aforesaid technical effects/advantages and other technical effects/advantages of the invention will be apparent in greater detail from the description set forth below of an example of an embodiment given by way of non-limiting illustration with reference to the appended drawings.

### BRIEF DESCRIPTION OF THE DRAWINGS

FIG. 1 is a block diagram of the device of the invention.

FIG. 1A is a specific block diagram of a block of FIG. 1.

FIG. 1B is a specific block diagram of a block of FIG. 1.

FIG. 1C is a specific block diagram of a block of FIG. 1.

FIG. 2 is a flowchart of the operations that can be carried out via a computer-implemented method according to the invention.

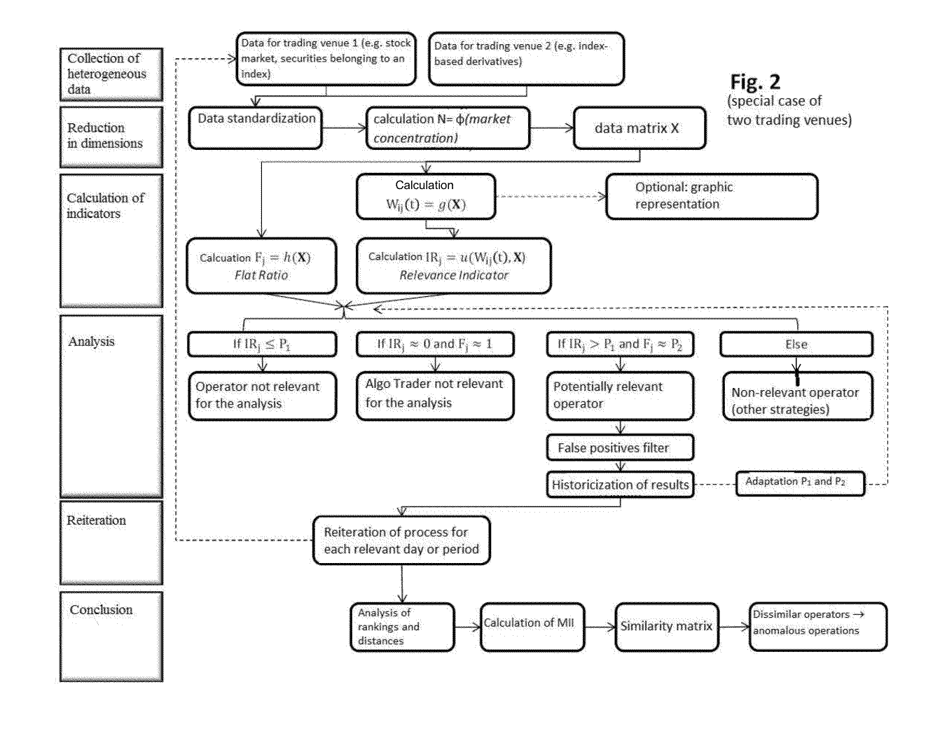

FIG. 3 is an example of application of the analysis of momentum ignition.

The measures developed have been defined as follows: “Value Weighted Average Time” (Wᵢⱼ(t)), “Relevance Indicator” (IRⱼ) and “Flat Ratio” (Fⱼ).

### DESCRIPTION OF THE PREFERRED EMBODIMENTS

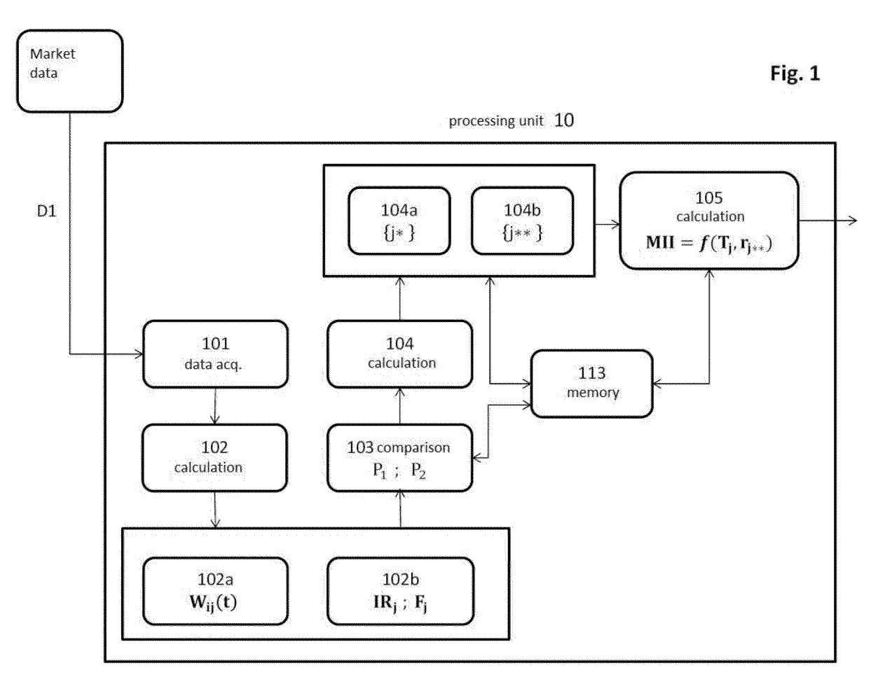

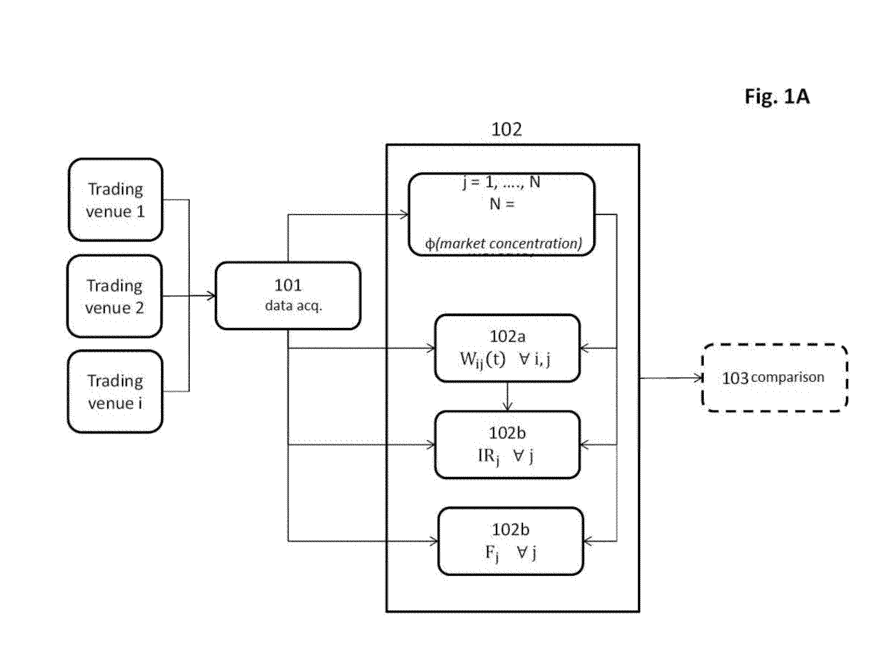

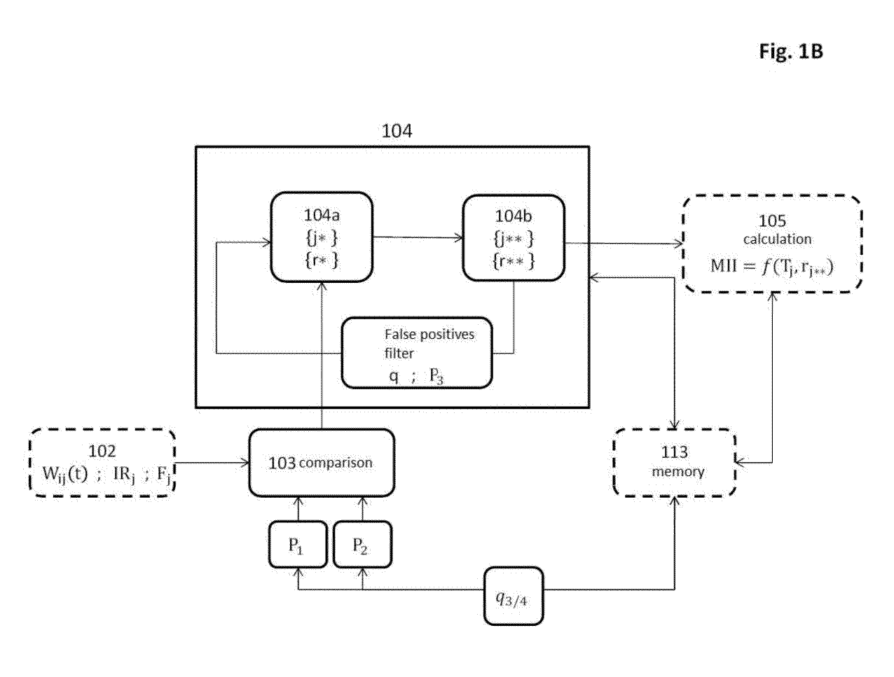

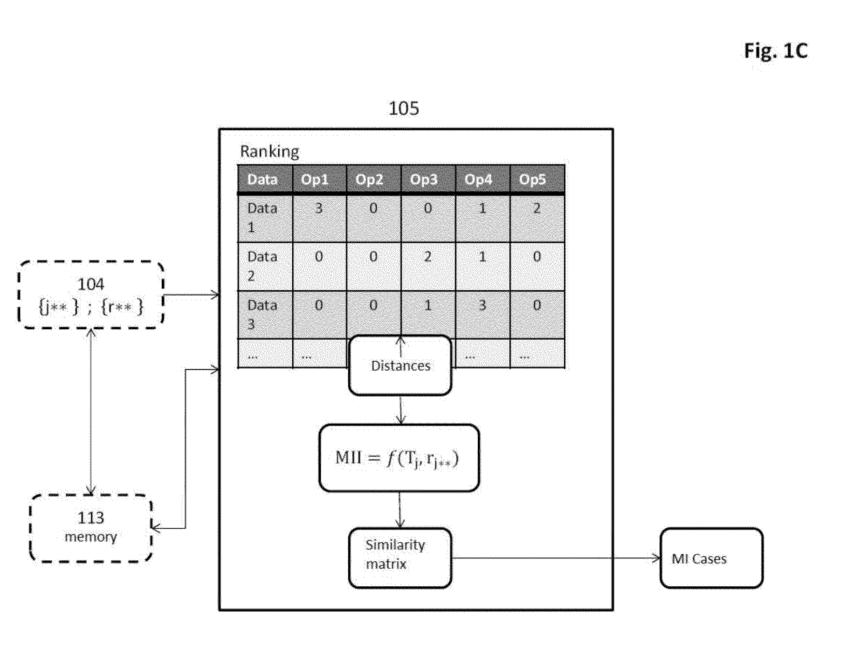

With particular reference to FIG. 1, there is shown a device 1 for processing data representative of financial transactions implemented by operators j.

The device according to the invention analyzes the daily transactions implemented by the operators j authorized to trade on several trading platforms (for example on the stock market and the derivatives market) in order to identify, among other things, the operations deemed to be suspect within the scope of the market abuse regulations.

More precisely, the device is capable of meeting the need present in the financial industry to identify, with a reasonable degree of approximation, the transactions ascribable to the so-called momentum ignition strategy.

Preferably, for each relevant session or period of reference, the first N operators who are most active in terms of the overall equivalent value traded on stocks with greatest capitalization and the related index-based derivatives are selected.

More in general, the index j=1, . . . , N is representative of the first N operators in terms of market share on a daily basis or in the period of reference; the maximum number of operators to be included can be configured based on the degree of concentration of market shares in the trading venue of reference.

In a preferred embodiment, N is such that the sum of the market shares of the first N operators is greater than a predefined share q % (for example q=50%).

The device 1 comprises a processing unit 10 (FIG. 1).

In general, it should be noted that in the present context and in the subsequent claims, the processing unit 10 is presented as divided into distinct functional modules (memory modules or operational modules) for the sole purpose of describing the functions thereof in a clear and complete manner.

In reality, the processing unit 10 can consist of a single electronic device, duly programmed to perform the functions described, and the various modules can correspond to hardware entities and/or routine software applications belonging to the programmed device.

Alternatively, or in addition, such functions can be performed by a plurality of electronic devices over which the aforesaid functional modules can be distributed.

The processing unit 10 can rely, moreover, on one or more processors for executing the instructions contained in the memory modules.

The aforesaid functional modules can also be distributed over different local or remote computers based on the architecture of the network they reside in.

The processing unit 10 is configured to process data representative of financial transactions D1.

According to the invention, the processing unit 10 comprises, for this purpose, a module 101 for acquiring said data D1.

Preferably, the data are imported from a transaction monitoring program or, alternatively, they can be entered manually or by uploading from an external storage medium.

As shown in FIG. 1, the processing unit 10 comprises a calculation module 102.

With particular reference to FIGS. 1 and 1a, the calculation module 102 comprises a first sub-module 102a.

Preferably, for every operator j (acting on his own behalf and on behalf of others) and relevant day or period selected, the sub-module 102a calculates an indicator of the average time for concluding contracts Wᵢⱼ(t), in particular as a weighted average time of the contracts of the operator.

The weighting variable is given by the equivalent value of each contract.

The index i is an even integer that takes on values from 2 to Y, where Y is the total number of indicators calculated for each operator j.

In a preferred embodiment, a summary indicator Wᵢⱼ(t) is calculated separately for buying and selling on each trading venue. In the case of two trading venues, for each operator there will be a vector W consisting of 4 indicators Wᵢⱼ(t). For example, for a given operator j and day the indicator Wᵢⱼ(t) for the purchases made on the stock market (i=1) will be calculated as:

$${W}_{1 j} ( t ) = {\sum }_{s = 1}^{S} {w}_{s} {t}_{s}$$

where S in this case represents the total number of stock purchase agreements concluded by the operator j, wₛ is the weight attributed to the s-th contract (i.e. the equivalent value of the contract compared to the total equivalent value of the stock purchases of that operator), tₛ is the time of conclusion of the s-th contract expressed in an appropriate temporal unit.

The output in the case of two trading venues, for example for stocks and the related derivatives, is thus given by a vector of four elements, calculated for each operator and day (or period of interest):

w̅={w_{CASHbuy},w_{CASHsell},w_{DERbuy},w_{DERsell}}={w₁,w₂,w₃,w₄}

where CASH and DER respectively indicate the stock market (for example the whole of securities belonging to an index) and the related derivative instruments (also index-based) and buy and sell respectively indicate purchases and sales.

Advantageously, according to the invention, the resulting average time indications do not refer to the exact moment of the buying or selling of stocks or derivatives by the operator, but rather represent summary values to be used for the purpose of making comparisons between operators and as an input for further analyses.

With particular reference to FIGS. 1 and 1a, the calculation module 102 comprises a second sub-module 102b. Advantageously, according to the invention, the second sub-module 102b is configured to calculate a first analysis indicator IRⱼ representative of a relevance of the operator j in assessing the presence of momentum ignition.

Primarily, the second sub-module 102b is configured to calculate the first indicator IRⱼ as a function of the data representative of financial transactions D1 and the summary indicator Wᵢⱼ(t).

In particular, according to the invention, the first analysis indicator IRⱼ is defined as a function of the financial transactions D1, the residual time (relative to Wᵢⱼ(t)) until closure of the market τᵢⱼ, and the traded equivalent value MTMᵢⱼ.

In other words, the first analysis indicator IRⱼ is defined as IRⱼ=u(Wᵢⱼ(t), MTMᵢⱼ).

In a preferred embodiment, the first indicator IRⱼ representative of the relevance of the operator j in assessing the presence of momentum ignition is calculated by the second sub-module 102b as follows:

$${IR}_{j} = d \cdot \frac{\begin{matrix}{MTM}_{2 j} \cdot {τ}_{2 j} + {MTM}_{4 j} \cdot {τ}_{4 j} - \\ {MTM}_{1 j} \cdot {τ}_{1 j} + {MTM}_{3 j} \cdot {τ}_{3 j}\end{matrix}}{{MTM}_{j}} \cdot {k}_{j}$$

where:
d is set equal to 1 if a bearish momentum occurs;
d=−1 if a bullish momentum occurs;
kⱼ=market share of the operator j relative to the total equivalent value traded by the N operators selected on the relevant day or in the relevant period considered;
MTMⱼ=MTM₁ⱼ+MTM₂ⱼ+MTM₃ⱼ+MTM₄ⱼ represents the total value traded by the operator j;
τᵢⱼ=time until closure of the market relative to Wᵢⱼ(t)

In a preferred embodiment of the invention, IRⱼ is calculated for each relevant day or period and for each operator/account.

Advantageously, according to the invention, the second sub-module 102b is configured to calculate a second indicator Fⱼ representative of an approximate value of a periodic closure of transactional positions for the operator j.

The second sub-module 102b is configured to calculate the second indicator Fⱼ as a function of the financial transaction data D1.

In particular, according to the invention, the second indicator Fⱼ is defined as a function of the traded equivalent value MTMᵢⱼ and the notional value of the derivative products, namely, futures. As is well known, futures are forward contracts that are standardized and can thus be traded in regulated markets, and under which an operator commits to buy or sell a certain amount of commodities or financial assets at a predetermined price and future maturity date.

In other words, the second indicator Fⱼ is defined, in a preferred embodiment, as Fⱼ=h(MTMᵢⱼ).

In a second, more general preferred embodiment, the indicator Fⱼ can be calculated by weighting the transactions on derivative products for their respective sensitivity relative to the variation of the underlying (known as the Delta coefficient).

In other words, the second preferred embodiment expresses the positions in derivatives in the number of equivalent futures and is defined as Fⱼ*=h₁(MTMᵢⱼ, Delta(k)), where the index k indicates that the coefficient Delta is calculated separately for each transaction.

In a further third preferred and even more general form of representation, the indicator Fⱼ can also be calculated as a function of the sensitivity of Delta with respect to variation in the underlying (known as the Gamma coefficient).

In the first preferred embodiment, the second indicator Fⱼ representing a value indicative of a periodic closure of transactional positions for the operator j is calculated by the calculation module 102 as follows:

$${F}_{j} = \frac{min ( {MTM}_{1 j} + {MTM}_{3 j} , {MTM}_{2 j} + {MTM}_{4 j} )}{max ( {MTM}_{1 j} + {MTM}_{3 j} \cdot {MTM}_{2 j} + {MTM}_{4 j} )}$$

According to the invention, the second indicator Fⱼ can take on values comprised between 0 and 1.

If the second indicator Fⱼ has values close to 1, it is representative of a net equivalent value traded by the operator (understood as the net position between buying and selling on the two platforms) close to the break-even (flat) position.

Therefore, for index values close to 1 it can considered reasonable to assume that the operator has opened and subsequently closed or covered his/her positions during the day or in the reference period.

The table that follows summarizes the representative parameters processed by the device of the invention.

| | | τᵢⱼ | MTMᵢⱼ |
|---|---|---|---|
| ij | | (time until | (traded |
| (i = 1 . . . 4) | Wᵢⱼ | closure of the | equivalent |
| (j = 1 . . . 10) | (VWAT) | market) | value) |
| 1j = “CASHbuy” | W₁ⱼ = W_{CASHbuy} | Closing time- | MTM₁ⱼ |
| operator j | operator j | W₁ⱼ | |
| 2j = “CASHsell” | W₂ⱼ = W_{CASHsell} | Closing time- | MTM₂ⱼ |
| operator j | operator j | W₂ⱼ | |
| 3j = “DERbuy” | W₃ⱼ = W_{DERbuy} | Closing time - | MTM₃ⱼ |
| operator j | operator j | W₃ⱼ | |
| 4j = “DERsell” | W₄ⱼ = W_{DERsell} | Closing time - | MTM₄ⱼ |
| operator j | operator j | W₄ⱼ | |

With reference to FIG. 1, the device 1 according to the invention further comprises a comparison module 103.

The comparison module 103 is configured to compare, for each operator j, the first analysis indicator IRⱼ with a respective first predefined value P₁, and the second indicator Fⱼ with a respective second predefined value P₂.

According to the invention, the first predefined value P₁ is representative of a predefined relevance of the operator j in assessing the presence of momentum ignition.

According to the invention, the second predefined value P₂ is representative of a value of a periodic closure of transactional positions for the operator j.

In other words, the comparison module 103 is configured to compare, for each operator j, the first indicator IRⱼ and the second indicator Fⱼ with respective predefined values P₁, P₂, wherein said predefined values are representative, respectively, of the relevance of the operators in assessing the presence of momentum ignition, and of a value of a periodic closure of transactional positions for the operators j.

In the preferred embodiment,
the first predefined value P₁≈0;
the second predefined value P₂≈1.

In another preferred embodiment, usable if a sufficiently broad sample of analyses is available (at least 30 sessions or periods of reference) the first and second predefined values P₁ and P₂ can be differently calibrated so as to be better adapted to the trading venues in question.

In particular, the first and second predefined values P₁ and P₂ can be placed in the third sample quartile of the respective available historical series.

The comparison module 103 is configured, moreover, to determine, as a function of the aforesaid comparisons, whether the operator j is relevant (that is, becomes j*) for an assessment of the presence of momentum ignition (MI).

In other words, the comparison module 103 checks if the first indicator IRⱼ and the second indicator Fj are jointly representative of a possible behaviour of momentum ignition MI; if the condition is verified, then the operator j is considered potentially relevant (j*) per evaluating the presence of MI.

More precisely, the comparison module 103 evaluates whether the first indicator IRⱼ is greater than or equal to the first predefined value P₁ and whether the second indicator Fⱼ is greater than or equal to the second predefined value P₂.

In particular, in a preferred embodiment, P2 is about equal to 1.

In still other words, if IRⱼ>P₁ and Fⱼ≈1, then a possible case of momentum ignition is identified, i.e. MI=TRUE.

The processing unit 10 further comprises a memory module 113 in data connection with the comparison module 103 and configured to store the values of the due indices IRᵢⱼ and Fⱼ of the relevant operators j*.

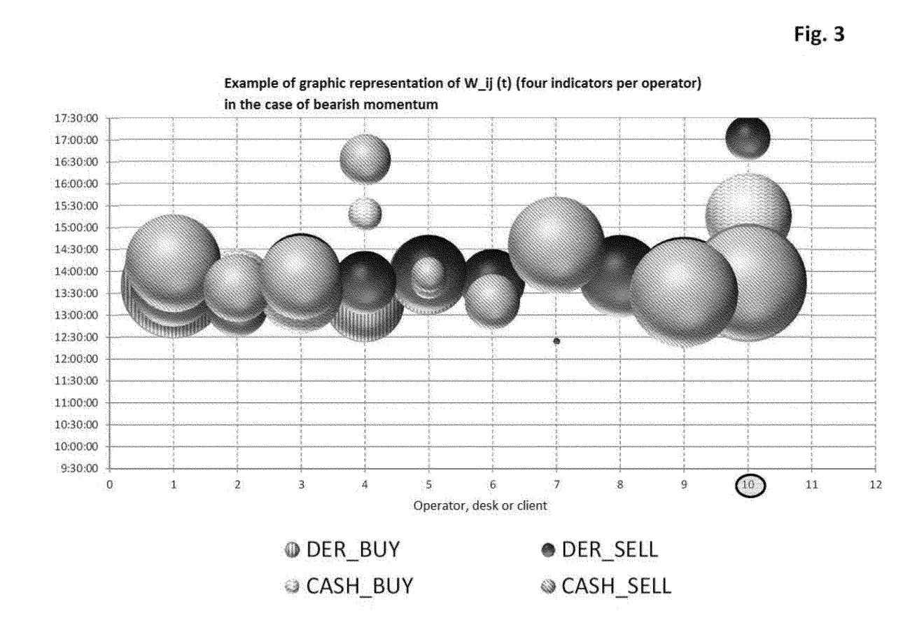

Jointly examining the indicators IRⱼ and Fⱼ makes it possible, more in general, to identify the following operational schemes, explained also in reference to FIG. 3:
IRⱼ<P₁: operator j not relevant for the purposes of analyzing momentum ignition.
IRⱼ≈0 e Fⱼ≈1: operator j identified as algo trader (that is, an operator who makes investment decisions on the basis of predefined algorithms) who operates with frequent buying and selling transactions on the stock and derivatives market with continuous openings and closings of positions that are very close together in time and a daily cross-market position of zero or nearly zero; the corresponding graphic representation in FIG. 3 (Example of graphic representation of VWAT in the case of a bearish momentum) consists of bubbles that are nearly perfectly superimposed.

These operators may not be relevant for the purposes of activating the momentum, but their algorithms could be activated by the momentum, increasing the amplitude and duration thereof;
IRⱼ>0 e Fⱼ≈1: operator potentially relevant for the present analysis (graphically, bubbles that are distant from one another and arranged according to a sequence coherent with the momentum);
IRⱼ>>0 e Fⱼ<1: operations potentially explainable with other strategies (by way of example, trading activity concentrated on individual financial instruments around the maturity dates relevant for the security in question).

It should be noted that this method of analysis can also be used on an intraday level, in particular for days characterized by a high degree of volatility of stock performance.

More in detail, FIG. 3 shows an efficient graphic representation of W representative of the operations of N operators.

In particular, this figure shows a bubble chart.

Each bubble provides indications as to the operations of the N operators considered (in the figure there is a representation for N=10) and should be interpreted as follows:

In particular:
the ordering of the elements makes it possible to identify the operators who are likely to have derived a profit from the momentum of a particular day;
the distance between elements within the vector is proportional to the profit obtained by the operator, given the correct ordering relative to momentum; moreover, it is essential to observe how the distance between the elements of the vector makes it possible to identify the operators who frequently open and close positions or implement strategies of hedging between stocks and derivatives (reduced distances) distinguishing them from operators who assume directional positions (large distances);
the distance of the elements among different operators makes it possible, finally, to identify the operators who may have activated the momentum.

In this example, the intermediary identified by j=10 is relevant for the strategy of momentum ignition. This result is confirmed by the relevance indicator (IRⱼ).

With particular reference to FIGS. 1 and 1B, according to the invention, the processing unit 10 comprises an analysis module 104.

With particular reference to FIG. 1B, the analysis module 104 comprises two sub-modules. The ordering sub-module 104a is configured to attribute a ranking r* to the relevant operators j* representative of a possible behaviour of momentum ignition MI in which the relevant operators j* have been selected by the module 103.

The analysis module 104 further contains a sub-module 104b configured to minimize the number of false positives potentially present in the set of operators j*.

In other words, the sub-module 104b has the objective of reducing the list of operators initially selected as relevant (operators j*) so as to obtain a list of operators from which possible false positives (operators j**) have been excluded.

In a preferred embodiment, the module 104b eliminates from the analysis any operators who, though judged relevant on the basis of the joint use of the two preceding criteria (IRⱼ and Fⱼ) used in the module 103, are not among the first operators in terms of IRⱼ in the session or period of reference.

From an economic viewpoint, this circumstance could correspond to the presence of operators who have implemented strategies other than momentum ignition and therefore represent a false positive for the purposes of analyzing momentum ignition MI.

More in particular, the module 104b verifies whether the first relevant operator j* is preceded by other operators for whom IRⱼ is higher than IR_{j*} but Fⱼ<P₂.

If this condition occurs, the module adds up the market shares kⱼ (defined above) of the operators j who meet the aforesaid condition.

If the sum of these market shares exceeds a critical threshold P₃, the module 104b will not include the operator j* in the list of the operators j**.

Finally, for each session analyzed, the module 104b attributes a relevance ranking r** to the first three operators j** (if present).

The modules 104a and 104b are in turn connected to the memory module 113 so as to store the codes and ranking of the relevant operators j**. Once the operators j** have been identified for a significant number of sessions, it is possible to compare the rankings r** recorded by the various operators in the various sessions, also by applying common techniques of nonparametric analysis on the rankings rather than on the absolute values of the individual indicators. Analyzing the historical data of the rankings enables very reliable results to be obtained.

For this purpose, the processing unit 10 comprises an analysis module 105 configured to calculate a consolidated momentum ignition index MII of the presence of MI for the selected operators j** as a function of a combination of rankings r** obtained in a plurality of findings in temporal succession Tj**

With particular reference to FIG. 1c, in a preferred, but not exhaustive, embodiment, the module 105 is configured to examine the historical results obtained in the sessions or periods of reference analyzed and, for each session or period of reference, to assign a value 1 if the operator j** has a ranking of 1 or 2, or otherwise a value of 0.

In this manner, a historical series of 0 and 1 for each operator j** is obtained.

The module 105 is also configured to proceed by calculating a distance measurement for dichotomous values for all possible pairs of operators.

In a preferred embodiment, the module 105 is configured to calculate the distance known as the Hamming distance for all pairs of operators j**.

The result can be usefully represented with a data matrix known as similarity matrix.

The operators who show high values in the similarity matrix can be considered dissimilar relative to the other operators and therefore emerge significantly in the analysis of momentum ignition MI.

The activity of the operators who, according to the procedure described, consistently emerge as anomalous over time is worthy of further assessment for the purposes of MI.

The invention also describes a method for processing data representative of financial transactions.

In a preferred embodiment, the method of the invention is implemented by means of a computer.

In other words, the device 1 described is a computer comprising the processing unit 10, in which the steps of the method for processing data D1 representative of financial transactions are carried out.

The computer-implemented method for processing data D1 representative of financial transactions implemented by operators j comprises the step of collecting (101) data representative of financial transactions D1.

The method further comprises the step of calculating (102) a first summary indicator Wᵢⱼ(t) and two analysis indicators IRⱼ and Fⱼ.

In particular, this step comprises calculating a first vector (for each operator j) of summary indicators w̅ consisting of the summary elements Wij(t) representative of the operations of each operator j, a first analysis indicator IRj representative of the operator j in assessing the presence of momentum ignition MI, and a second analysis indicator Fj representative of a value of a periodic closure of transactional positions for the operator j.

The method then envisages comparing, for each operator j, the first indicator IRⱼ and the second indicator Fⱼ with respective predefined values P₁, P₂, wherein said predefined values can be made automatically adaptable over time by means of suitable thresholds on the sampling distribution of findings.

In particular, P₁ and P₂ can take on predefined values or else be conveniently established based on the historical distribution of IRⱼ and Fⱼ.

Even more particularly, P1, P2 respectively represent the relevance of the operators in assessing the presence of momentum ignition and a value of a periodic closure of transactional positions.

A more complete discussion is set forth in the part of the description regarding the device.

Furthermore, the method envisages determining, based on the aforementioned comparisons, whether the operator j is relevant (j*) for an assessment of the presence of momentum ignition.

The method then envisages attributing a ranking r* to the relevant operators j* who are representative of a possible behaviour of momentum ignition.

The method also envisages eliminating any false positives so as to arrive at a list of relevant operators j** with a corresponding ranking r**.

The procedure of eliminating false positives is automatic and is based on comparing the operations and market shares of the operators j.

Preferably, the method further comprises the step of calculating a consolidated index MII of the presence of momentum ignition for each relevant operator j** as a function of a combination of the rankings r** of the same operators obtained in a plurality of findings in temporal succession Tj.

The invention as described achieves the “further technical effects” of ensuring a precise temporal analysis of an activation of a momentum ignition strategy MI, an objective recognition of a situation of momentum ignition MI, a reduction in the time needed to analyze a probable situation of momentum ignition MI, a real-time analysis of momentum ignition MI, and a rapid, simple analysis of historical data of momentum ignition MI.

In other words, the invention makes it possible to identify strategies undertaken through several markets, also by combining products of a different nature (such as, for example, stocks and index-based derivative products), compare data among the various market participants and analyze data also originating from different markets; all this enables the input information (also that originating from platforms with heterogeneous protocols) to be standardized and serves to ensure the “further technical effect” of being able to interpret the data in order to recognize the specific case being looked for.

The algorithm is based on information available on any trading platform and makes it possible to save on the hours of work formerly necessary for the subjective interpretation of the data and to analyze historical data (back-testing) automatically and in a short time.

1. A device (1) for processing data representing financial transactions (D1) implemented by operators (j), wherein the device (1) comprises a processing unit (10) configured to process said data (D1), wherein the processing unit (10) comprises;
an acquisition module (101) of said data representing financial transactions (D1);
a first calculation module (102) configured to calculate, for each operator:
a first vector ( w̅) of summary indicators Wij(t) representing the operability of each operator (j);
a first analysis indicator (IRj) representing a relevance of said operator (j) in an assessment of the presence of momentum ignition (MI);
a second analysis indicator (Fj) representing a value of a periodic closure of transactional positions for said operator (j);
the first calculation module (102) being configured to calculate said summary indicator (Wij(t)) and the first (IRj) and the second (Fj) analysis indicator as a function of said data representing financial transactions (D1);
a comparison module (103) configured to:
compare, for each operator (j), the first analysis indicator (IRj) and the second analysis indicator (Fj) with respective predefined values (P1, P2) of relevance, wherein the predefined values represent respectively a relevance of the operator (j) in assessment of the presence of a momentum ignition (MI) and a value of a periodic closure of transactional positions for said operator (j);
determine, as a function of the comparisons, if the operator (j) is relevant (j*) for an assessment of the presence of the momentum ignition (MI) and if the first analysis indicator (IRj) and the second analysis indicator (Fj) are representative of possible momentum ignition (MI) behaviour.

2. The processing device (1) according to claim 1, wherein the processing unit (10) also comprises:
an analysis module (104) configured to:
attribute a ranking (11 to the relevant operators (j*) and representing the possible momentum ignition (MI) behaviour;
obtain a new list of relevant operators (j**) excluding any possible false positives among the operators (j*).

3. The data processing device (1) according to claim 1, wherein the processing unit (10) comprises an analysis module (105) configured to calculate a consolidated index (MII) of presence of the momentum ignition (MI) for the relevant operators (j**) as a function of a combination of the rankings (r**) obtained in a plurality of findings in temporal succession (Tj).

4. The data processing device (1) according to claim 2, wherein the processing unit (10) comprises an analysis module (105) configured to calculate a consolidated index (MII) of presence of the momentum ignition (MI) for the relevant operators (j**) as a function of a combination of the rankings (r**) obtained in a plurality of findings in temporal succession (Tj).

5. The data processing device (1) according to claim 1, wherein the calculation module (102) comprises a first sub-module (102a) configured to calculate the first analysis indicator (IRj) as a function of the summary indicator (Wij(t)), of a residual time until closure of the market (TO and of a traded equivalent value (MTMij).

6. The data processing device (1) according to claim 5, wherein the calculation module (102) comprises a second sub-module (102b) configured to calculate the second analysis indicator (Fj) as a function of the traded equivalent value (MTMij).

7. The data processing device (1) according to claim 6, wherein the second sub-module (102b) is configured to calculate the second analysis indicator (Fj) as a function of the traded equivalent value (MTMij) and as a function of Delta and Gamma coefficients calculable for derivatives.

8. The device (1) according to claim 1, wherein the comparison module (103) is configured to determine whether the first indicator (IRj) and the second indicator (Fj) represent the possible momentum ignition (MI) behaviour, assessing whether:
the first indicator (IRj) is higher than or equal to the first predefined value (P1);
the second indicator (Fj) is higher than or equal to the second predefined value (P2).

9. The device (1) according to claim 2, wherein the analysis module (104) comprises:
a first sub-module (104a) configured to attribute the ranking (r*) as a function of the first analysis indicator (IRj>0);
a second sub-module (104b) configured to eliminate false positives as a function of market shares of the operators (j), wherein the first analysis indicator (IRj) is higher than a predefined value (IRj*), with IRj>IRj thus determining a list of relevant operators (j**) and the relative rankings (r**) minus the false positives.

10. The device (1) according to claim 3, wherein the analysis module (104) comprises:
a first sub-module (104a) configured to attribute the ranking (r*) as a function of the first analysis indicator (IRj>0);
a second sub-module (104b) configured to eliminate false positives as a function of market shares of the operators (j), wherein the first analysis indicator (IRj) is higher than a predefined value (IRj*), with IRj>IRj thus determining a list of relevant operators (j**) and the relative rankings (r**) minus the false positives.

11. The device (1) according to claim 4, wherein the analysis module (104) comprises:
a first sub-module (104a) configured to attribute the ranking (r*) as a function of the first analysis indicator (IRj>0);
a second sub-module (104b) configured to eliminate false positives as a function of market shares of the operators (j), wherein the first analysis indicator (IRj) is higher than a predefined value (IRj*), with IRj>IRj thus determining a list of relevant operators (j**) and the relative rankings (r**) minus the false positives.

12. The device (1) according to claim 2, wherein the processing unit 10 comprises a memory module (113), in data connection with the comparison module (103) and the analysis module (104), and configured to store the values of the first analysis indicator ((IRj) of the relevant operators (j* e j**) and the relative rankings (r* and r**).

13. The device (1) according to claim 3, wherein the processing unit 10 comprises a memory module (113), in data connection with the comparison module (103) and the analysis module (104), and configured to store the values of the first analysis indicator ((IRj) of the relevant operators (j* e j**) and the relative rankings (r* and r**).

14. The device (1) according to claim 12, wherein the processing unit (10) comprises an analysis module (105) configured to calculate a consolidated index (MII) of presence of MI for the relevant operators (j**) as a function of a combination of rankings (r**) of the same relevant operator (j**) obtained in a plurality of findings in temporal succession (Tj).

15. The device (1) according to claim 13, wherein the processing unit (10) comprises an analysis module (105) configured to calculate a consolidated index (MII) of presence of MI for the relevant operators (j**) as a function of a combination of rankings (r**) of the same relevant operator (j**) obtained in a plurality of findings in temporal succession (Tj).

16. The device (1) according to claim 1, wherein the predefined values (P1, P2) of relevance are determined as a function of distribution of the random historical findings of the first analysis indicator (IRj) and the second analysis indicator (Fj).

17. A method for processing data (D1) representing financial transactions implemented by operators (j), comprising the steps of:
collecting (101) data representing financial transactions (D1);
calculating (102), for each operator (j):
a first vector (W) of summary indicators Wij(t) representing operability of each operator (j);
a first analysis indicator (IRj) representing a relevance of the operator (j) in an assessment of the presence of momentum ignition (MI);
a second analysis indicator (Fj) representing a value of a periodic closure of transactional positions for the operator (j);
the first calculation module (102) being configured to calculate the summary indicator (Wij(t)) and the first (IRj) and second (Fj) analysis indicator as a function of the data representing financial transactions (D1);
comparing, for each operator (j), the first analysis indicator (IRj) and the second analysis indicator (Fj) with respective predefined values (P1, P2) of relevance, wherein the predefined values represent respectively a relevance of the operator (j) in the assessment of the presence of momentum ignition (MI) and a value of periodic closure of transactional positions for the operator (j);
determining, as a function of the comparisons, whether the operator (j) is relevant (j*) for an assessment of the presence of the momentum ignition (MI) and whether the first analysis indicator (IRj) and the second analysis indicator (Fj) represent possible momentum ignition (MI) behaviour.

18. The method according to claim 17, further comprising the steps of:
attributing a ranking (r*) to the relevant operators (j*) and representing the possible momentum ignition (MI) behaviour;
obtaining a new list of relevant operators (j**) excluding any false positives among the operators (r).

19. The method according to claim 17, further comprising the steps of:
calculating a consolidated index (MII) of the presence of said momentum ignition (MI) for said relevant operators (j**) as a function of a combination of said rankings (r**) obtained in a plurality of findings in temporal succession (Tj).

20. The method according to claim 18, further comprising the step of:
calculating a consolidated index (MII) of the presence of said momentum ignition (MI) for said relevant operators (j**) as a function of a combination of said rankings (r**) obtained in a plurality of findings in temporal succession (Tj).
